(19) United States
(12) Patent Application Publication
(10) Pub. No.: US 2025/0125355 A1
(43) Pub. Date: Apr. 17, 2025

(54) ELECTROCHEMICAL DEVICE AND ELECTRONIC DEVICE

(71) Applicant: Ningde Amperex Technology Limited, Ningde (CN)

(72) Inventors: Zheng YI, Ningde (CN); Zigui ZHENG, Ningde (CN); Yuansen XIE, Ningde (CN)

(73) Assignee: Ningde Amperex Technology Limited, Ningde (CN)

(21) Appl. No.: 18/999,094

(22) Filed: Dec. 23, 2024

Related U.S. Application Data
(63) Continuation of application No. PCT/CN2022/100662, filed on Jun. 23, 2022.

(51) Int. Cl. H01M 4/583; H01M 4/02; H01M 4/04; H01M 10/0525

(52) U.S. Cl. CPC H01M 4/583; H01M 4/0471; H01M 10/0525; H01M 2004/021; H01M 2004/027

(57) ABSTRACT

A negative active material in the negative active material layer includes hard carbon. An H/C value of the hard carbon is 0.05 to 0.18. A CB value of the electrochemical device is 0.95 to 1.05. This application uses hard carbon as a negative active material. By adjusting the H/C value of the hard carbon and the CB value of the electrochemical device, this application can increase the energy density without lithium precipitation, that is, alleviate lithium precipitation and increase the energy density concurrently.

### CROSS REFERENCE TO RELATED APPLICATION

This application is a continuation application of International Application No. PCT/CN2022/100662, filed on Jun. 23, 2022, the content of which is incorporated herein by reference in its entirety.

### TECHNICAL FIELD

This application relates to the technical field of lithium batteries, and in particular, to an electrochemical device and an electronic device.

### BACKGROUND

Lithium-ion batteries are widely used in the field of portable consumer electronics by virtue of high volumetric and gravimetric energy densities, environmental friendliness, a high operating voltage, a small size, a light weight, a long cycle life, and other advantages. In recent years, with rapid development of electric vehicles and portable electronic devices, people are putting forward higher requirements on the energy density, safety, cycle performance, and other performance metrics of the battery, and are expecting the rollout of a new lithium-ion battery with higher overall performance. Among the performance metrics, energy density and cycle performance have become pressing key technical challenges. Improving the active materials in an electrode of the battery is one of the research topics to address the above technical issues.

Currently, graphite is the most widely used negative electrode material, and possesses the advantages such as low polarization and a stable charge-discharge plateau. However, the performance of commercial graphite has been almost developed to the extreme degree. On the premise of no lithium precipitation, the reversible gravimetric capacity and energy density of the commercial graphite can hardly be improved any further. Therefore, developing new alternative negative electrode materials is one of the research topics to solve the current problem of a low energy density of lithium-ion batteries.

### SUMMARY

An embodiment of this application provides an electrochemical device and an electronic device. By using hard carbon as an active material and adjusting the H/C value of the hard carbon and the CB value of the electrochemical device, this application can increase the energy density without lithium precipitation, that is, alleviate lithium precipitation and increase the energy density concurrently.

First, an embodiment of this application provides an electrochemical device. The electrochemical device includes a negative electrode plate. The negative electrode plate includes a negative active material layer. A negative active material in the negative active material layer includes hard carbon. An H/C value of the hard carbon is 0.05 to 0.18. A CB value of the electrochemical device is 0.95 to 1.05. The H/C value is a molar ratio of H element to C element in the hard carbon, and the CB value is a ratio of a capacity per unit area of the negative electrode plate to a capacity per unit area of the positive electrode plate. By controlling the molar ratio of the H element to the C element in the hard carbon to fall within the range of 0.05 to 0.18, the molar ratio of the H element to the C element in the negative active material layer is controlled to range from 0.1 to 0.5. The molar ratio of the H element to the C element in the negative active material layer falls within an appropriate range, thereby increasing the transmission speed of active ions. In addition, the CB value of the electrochemical device is controlled to range from 0.95 to 1.05. The coordination of the two parameters increases the energy density of the electrochemical device and alleviates the lithium precipitation of the electrochemical device.

When tested through thermal analysis, the negative electrode plate in the fully charged state (that is, 100% SOC) exhibits a thermal weight loss peak in a range of 150° C. to 220° C., with a peak area being greater than 100 J/g. The thermal weight loss peak is a thermal weight loss peak of metallic lithium or the like in the micropores of hard carbon. The peak area of the thermal weight loss peak shows the same tendency as the energy density of the electrochemical device. In other words, the larger the peak area, the larger the amount of metallic lithium or the like stored in the same area of the electrode plate, and therefore, the higher the energy density of the lithium-ion battery. The peak area of the thermal weight loss peak is used for representing the lithium storage characteristics of hard carbon. In an XRD diffraction pattern of the negative electrode plate, a diffraction peak A1 is exhibited in a range of 20° to 30° of the 2θ diffraction angle. The full-width-at-half-maximum of the diffraction peak falls within a range of 3° to 10°. The diffraction peak A1 is a characteristic peak of hard carbon. In a Raman spectrum of the negative electrode plate, a characteristic peak D1 is exhibited in a range of 1320 cm⁻¹ to 1370 cm⁻¹, with the peak intensity denoted as I_{D1}. D1 is a disorder peak, and reflects the degree of disorder inside the carbon material. A characteristic peak G1 is exhibited in a range of 1570 cm⁻¹ to 1620 cm⁻¹, with the peak intensity denoted as IG1. G1 is a graphitization peak, and reflects the in-plane stretching vibration of sp² hybridized carbon atoms, satisfying: 0.5≤I_{D1}/I_{G1}≤1.5. By controlling the peak intensity ratio of I_{D1} to I_{G1} to fall within a range of 0.5 and 1.5, this application enables a relatively high transmission speed of lithium ions, and endows the electrochemical device with a relatively high energy density. If the peak intensity ratio I_{D1}/I_{G1} is less than 0.5, it means that the degree of disorder is low, the number of lithium storage sites in the hard carbon material is relatively small, and the reversible capacity is low, thereby impairing the C-rate performance of the lithium-ion battery. If the peak intensity ratio I_{D1}/I_{G1} is greater than 1.5, it means that the degree of disorder is overly high, thereby being unfavorable to the transmission of lithium ions and being prone to lithium precipitation.

In addition, the BET specific surface area of the hard carbon is 1.5 m²/g to 10 m²/g. If the BET value is overly large (for example, greater than 10 m²/g), the specific surface area is unfavorable to the processing, such as slurry mixing and coating, of the negative electrode plate during the preparation of the lithium-ion battery. In addition, an excessive BET value leads to a low first-cycle Coulombic efficiency of the lithium-ion battery, thereby hindering exertion of the energy density. If the BET value is overly small (for example, less than 1.5 m²/g), the specific surface area may impair the kinetic performance of the lithium-ion battery, thereby resulting in slight lithium precipitation. Moreover, the compacted density of the negative electrode plate denoted as P, satisfies: 0.85 g/cm³≤P≤1.1 g/cm³. The ratio of a value of the BET specific surface area expressed in m²/g of the hard carbon to a value of the compacted density P expressed in g/cm³ denoted as M (that is, BET/P=M), satisfies: M>1.7. By controlling the compacted density P of the negative electrode plate to fall within an appropriate range, this application increases the energy density of the electrochemical device. In addition, by controlling the ratio of the value of the BET value of the hard carbon to the value of the compacted density P of the negative electrode plate to be greater than 1.7, this application further increases the energy density of the electrochemical device and improves exertion of the kinetic performance.

Dᵥ₅₀ of particles of the hard carbon is 2 μm to 15 μm, where Dᵥ₅₀ is a particle diameter corresponding to a cumulative volume percent 50% in a volume-based particle size distribution curve. Dᵥ₉₉ of particles of the hard carbon is 8 μm to 45 μm, where Dᵥ₉₉ is a particle diameter corresponding to a cumulative volume percent 99% in a volume-based particle size distribution curve. The gravimetric capacity of the hard carbon at 0 V to 2.0 Vis 300 mAh/g to 1200 mAh/g. By controlling the particle diameter of the hard carbon to fall within an appropriate range, if the particle diameter of the hard carbon is overly small, the BET value of the hard carbon will be overly large, thereby not only being unfavorable to the processing of the negative electrode plate during the preparation of the lithium-ion battery, but also leading to a low first-cycle Coulombic efficiency of the prepared electrochemical device, and in turn, impairing the energy density. If the particle diameter of the hard carbon is overly large, the hard carbon is unfavorable to improving the kinetic performance of the electrochemical device. As can be seen, an appropriate particle size distribution is conducive to improving the kinetic performance of the electrochemical device, thereby increasing the energy density.

Further, a preparation process of the hard carbon includes the following steps: Treating a carbon source to produce a precursor, modifying the precursor, calcining the modified precursor for a first time, grading a calcination product, and calcining the grading product for a second time.

In the step of precursor modification, when the carbon source is biomass corn starch, the precursor modification is usually to place the carbon source in an air atmosphere, and oxidize the carbon source at 150° C. to 200° C. for 5 h to 20 h. When the carbon source is a biomass coconut shell, the precursor modification is usually to soak the carbon source in an alkaline solution, and hydrothermally heating the carbon source at 150° C. to 200° C. for 5 h to 20 h. When the carbon source is phenolic resin, the precursor modification is the same as that of the biomass corn starch. When the carbon source is asphalt, the carbon source needs to be soaked in an organic solution for 5 h to 10 h, and then oxidized at different temperatures for 5 h to 20 h to complete the precursor modification of the carbon source. The purpose of the precursor modification is to fix the pore characteristics of the precursor modification process, so as to retain the pores in the subsequent carbonization process. In the step of the first-time calcination, a product of the precursor modification is placed in an inert atmosphere and calcined at 500° C. to 600° C. for 2 h to 3 h, so as to preliminarily carbonize the precursor and fix the basic structure of the carbon material. In the step of grading, the product of the first-time calcination is crushed and graded, so as to pick out the desired particle size. In the step of second-time calcination, the product of the grading is kept in an inert atmosphere at ultra-high temperature for 2 to 3 hours to diminish or eliminate the functional groups in the carbon material, shrink the surface structure, reduce the specific surface area, and reduce the irreversible constituents.

Definitely, it is hereby noted that the temperature of the second-time calcination is usually not higher than 1000° C. When the temperature of the second-time calcination is higher than 1000° C., the preparation process further includes surface modification coating and third-time calcination after the second-time calcination. The surface modification coating is to place the product of the second-time calcination in a 10% CH₄—Ar mixed gas to undergo CVD coating. The surface modification coating and the third-time calcination are carried out simultaneously. That is, the product of the second-time calcination is placed in a 10% CH₄—Ar mixed gas, and is kept at a temperature below 1000° C. (third-time calcination) for 1 to 3 hours, so as to coat the surface of the carbon material particles with a carbon layer. The pyrolysis temperature of the coating layer formed by the surface modification coating is 700° C. to 1000° C. The irreversible functional groups and pore-forming constituents in the carbon material are diminished or eliminated by covering the surface of the hard carbon with the coating layer. In addition, the pyrolysis temperature of the coating layer is controlled to fall within a range of 700° C. to 1000° C., so as to deposit methane and retain a specified H/C ratio value, and ultimately obtain hard carbon with an H/C value of 0.05 to 0.18.

Finally, an embodiment of this application provides an electronic device. The electronic device includes any one of the electrochemical devices disclosed above.

The technical solutions provided in some embodiments of this application bring at least the following beneficial effects:

This application provides an electrochemical device. The electrochemical device includes a negative electrode plate. The negative electrode plate includes a negative active material layer. A negative active material in the negative active material layer includes hard carbon. An H/C value of the hard carbon is 0.05 to 0.18, and a CB value of the electrochemical device is 0.95 to 1.05. By controlling the molar ratio of the H element to the C element in the hard carbon to fall within the range of 0.05 to 0.18, the molar ratio of the H element to the C element in the negative active material layer is controlled to range from 0.1 to 0.5. The molar ratio of the H element to the C element in the negative active material layer falls within an appropriate range, thereby increasing the transmission speed of active ions. In addition, the CB value of the electrochemical device is controlled to range from 0.95 to 1.05, thereby increasing the energy density of the electrochemical device and alleviating the lithium precipitation of the electrochemical device.

### BRIEF DESCRIPTION OF DRAWINGS

To describe the technical solutions in some embodiments of this application or the prior art more clearly, the following outlines the drawings to be used in the description of some embodiments of this application or the prior art. Evidently, the drawings outlined below are merely a part of embodiments of this application. A person skilled in the art may derive other drawings from such drawings without making any creative effort.

FIG. 1 is a thermal analysis diagram of a negative electrode plate according to Embodiment 2 of this application; and

FIG. 2 is a particle size distribution curve of hard carbon particles according to Embodiment 2 of this application.

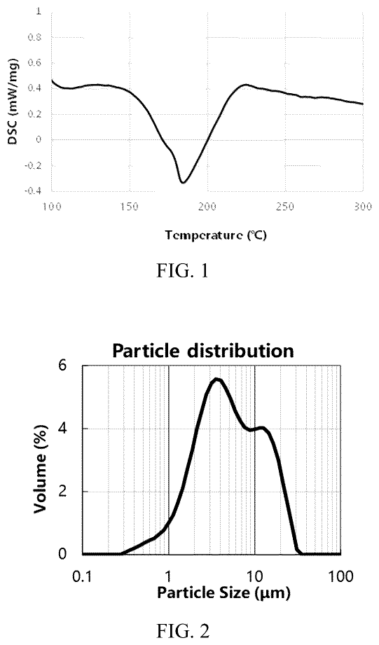

### DETAILED DESCRIPTION

To make the objectives, technical solutions, and advantages of this application clearer, the following describes this application in further detail with reference to drawings and embodiments. Understandably, the specific embodiments described herein are merely intended to explain this application, but are not intended to limit this application.

For brevity, just some of numerical ranges are expressly disclosed herein. However, any lower limit may be combined with any upper limit to form an unspecified range, any lower limit may be combined with any other lower limit to form an unspecified range, and any upper limit may be combined with any other upper limit to form an unspecified range. In addition, although not explicitly stated, any point and any single numerical value between end points of a range are included in the range. Therefore, each point or each single numerical value may be used as a lower limit or upper limit of the range to combine with any other point or other single numerical value or with any other lower or upper limit to form an unspecified range.

In the embodiments and claims, a list of items recited by using the terms such as “at least one of”, “at least one thereof”, “at least one type of” or other similar terms may mean any combination of the recited items. For example, if items A and B are listed, the phrases “at least one of A and B” and “at least one of A or B” mean: A alone; B alone; or both A and B. In another example, if items A, B, and C are listed, the phrases “at least one of A, B, and C” and “at least one of A, B, or C” mean: A alone; B alone; C alone; A and B (excluding C); A and C (excluding B); B and C (excluding A); or all of A, B, and C.

Currently, graphite is the most widely used negative electrode material, and possesses the advantages such as low polarization and a stable charge-discharge plateau. However, in order to avoid lithium precipitation at the negative electrode, the negative electrode capacity is generally higher than the positive electrode capacity in the graphite that is commercially available currently. Here it is defined that a ratio of the negative electrode capacity per unit area to the positive electrode capacity is a CB value, calculated as: CB value=negative electrode capacity per unit area/positive electrode capacity per unit area. The CB value of graphite is generally 1.04 to 1.08. However, a relatively high CB value results in a relatively low energy density of the battery. Therefore, the graphite negative electrode in the prior art is unable to achieve a high level of a plurality of performance metrics such as lithium precipitation suppression and energy density concurrently.

Hard carbon is one of the potential negative electrode materials that can replace graphite. The reversible gravimetric capacity of the hard carbon is up to 1 to 2 times that of graphite negative electrode. Therefore, when hard carbon is used as a negative electrode material of a lithium-ion battery instead of graphite, the energy density of the entire lithium-ion battery is expected to be increased to some extent. In addition, the hard carbon possesses different physical and chemical properties than graphite. For example, the pores of hard carbon is richer. Therefore, the hard carbon used as a negative electrode material of a lithium-ion battery is less prone to lithium precipitation than graphite. As a new negative electrode material, the hard carbon possesses a richer pore structure, and the potential of hard carbon relative to lithium is less than or equal to 0 V. Therefore, compared with graphite, the hard carbon with a low CB value is less prone to lithium precipitation. If the hard carbon is designed based on a graphite system, the energy density ED of the resultant electrochemical device is relatively low. Therefore, studying hard carbon systems with different H/C values and CB values is conducive to improving the energy density of electrochemical devices and alleviating the lithium precipitation of the electrochemical devices.

### Electrochemical Device

To solve the above technical problems, this application discloses an electrochemical device. The electrochemical device includes a negative electrode plate, a separator, a positive electrode plate, and an electrolyte solution.

### Negative Electrode Plate

The negative electrode plate includes a negative current collector and a negative active material layer disposed on at least one surface of the negative current collector. A negative active material in the negative active material layer includes hard carbon. The value range of an H/C value of the hard carbon is 0.05 to 0.18. A CB value of the electrochemical device is 0.95 to 1.05. The H/C value is a molar ratio of H element to C element in the hard carbon, and the CB value is a ratio of a capacity per unit area of the negative electrode plate to a capacity per unit area of the positive electrode plate.

As an example, the H/C value of the hard carbon is 0.05, 0.08, 0.10, 0.12, 0.14, 0.16, 0.18, or a value falling within a range formed by any two thereof.

As an example, the CB value of the electrochemical device is 0.95, 0.97, 0.99, 1.01, 1.03, 1.05, or a value falling within a range formed by any two thereof.

Preferably, the H/C value of the hard carbon is 0.05 to 0.15. As an example, the H/C value of the hard carbon is 0.05, 0.06, 0.07, 0.09, 0.11, 0.13, 0.15, or a value falling within a range formed by any two thereof.

Further, preferably, the H/C value of the hard carbon is 0.08 to 0.15. As an example, the H/C value of the hard carbon is 0.08, 0.10, 0.11, 0.13, 0.15, or a value falling within a range formed by any two thereof.

Preferably, the CB value of the electrochemical device is 0.96 to 1.00. As an example, the CB value of the electrochemical device is 0.96, 0.97, 0.98, 0.99, 1.00, or a value falling within a range formed by any two thereof.

Further, preferably, the CB value of the electrochemical device is 0.98 to 1.00. As an example, the CB value of the electrochemical device is 0.98, 0.99, 1.00, or a value falling within a range formed by any two thereof.

In some embodiments, the electrochemical device satisfies at least one of the following conditions:

(1) In a thermal analysis test, the negative electrode plate in a fully charged state exhibits a thermal weight loss peak in a range of 150° C. to 220° C., with a peak area being greater than 100 J/g. Preferably, the peak area is greater than 110 J/g.

(2) In an X-ray diffraction pattern of the negative electrode plate, a diffraction peak A1 is exhibited in a range of 20° to 30° and possesses a full-width-at-half-maximum of 3° to 10°.

As an example, the full-width-at-half-maximum of the diffraction peak A1 is 3°, 5°, 8°, 10°, or a value falling within a range formed by any two thereof.

(4) In a Raman spectrum of the negative electrode plate, a characteristic peak D1 is exhibited in a range of 1320 cm⁻¹ to 1370 cm⁻¹, a characteristic peak G1 is exhibited in a range of 1570 cm⁻¹ to 1620 cm⁻¹, a peak intensity of the characteristic peak D1 is I_{D1}, and a peak intensity of the characteristic peak G1 is I_{G1}, satisfying: 0.5≤I_{D1}/I_{G1}≤1.5.

As an example, the peak intensity ratio I_{D1}/I_{G1} between the characteristic peak D1 and the characteristic peak G1 is 0.5, 0.8, 1.0, 1.2, 1.5, or a value falling within a range formed by any two thereof.

In some embodiments, the electrochemical device satisfies at least one of the following conditions:
(I) a BET specific surface area of the hard carbon is 1.5 m²/g to 10 m²/g;

As an example, the BET specific surface area of the hard carbon is 1.5 m²/g, 2 m²/g, 4 m²/g, 6 m²/g, 8 m²/g, 10 m²/g, or a value falling within a range formed by any two thereof.
(II) a compacted density of the negative electrode plate tested after being pressed under a 5-ton pressure, denoted as P, satisfies: 0.85 g/cm³≤P≤1.1 g/cm³; or

As an example, the compacted density P of the negative electrode plate is 0.85 g/cm³, 0.88 g/cm³, 0.98 g/cm³, 1.1 g/cm³, or a value falling within a range formed by any two thereof.
(III) a ratio of the value of the BET specific surface area expressed in m²/g of the hard carbon to the value of the compacted density P expressed in g/cm³ of the negative electrode plate is M, satisfying: M>1.7.

Preferably, the electrochemical device satisfies at least one of the following conditions:
(I′) The BET specific surface area of the hard carbon is 2 m²/g to 8 m²/g.

As an example, the BET specific surface area of the hard carbon is 2 m²/g, 3 m²/g, 5 m²/g, 6 m²/g, 8 m²/g, or a value falling within a range formed by any two thereof.
(II′) The compacted density of the negative electrode plate denoted as P, satisfies: 0.98 g/cm³≤P≤1.05 g/cm³.

As an example, the compacted density P of the negative electrode plate is 0.98 g/cm³, 1.0 g/cm³, 1.01 g/cm³, 1.03 g/cm³, 1.05 g/cm³, or a value falling within a range formed by any two thereof.
(III′) The ratio of the value of the BET specific surface area expressed in m²/g of the hard carbon to the value of the compacted density P expressed in g/cm³ of the negative electrode plate is M, satisfying: 2≤M≤9.

As an example, the ratio M of the value of the BET specific surface area expressed in m²/g of the hard carbon to the value of the compacted density P expressed in g/cm³ of the negative electrode plate is 2, 3, 5, 7, 9, or a value falling within a range formed by any two thereof.

The compacted density P may be calculated by a formula P=m/v, where m is the mass of the negative active material layer, in units of g, and v is the volume of the negative active material layer, in units of cm³. The volume v of the negative active material layer may be a product of the area S of the negative active material layer and the thickness h of the negative active material layer.

The specific surface area of the negative electrode material may be measured by a Brunauer-Emmett-Teller (BET) test method, including: first, using a Tri Star II specific surface analyzer, loading 3 to 6 grams of specimen into a specimen tube, and then putting the specimen into a degassing station; heating the specimen, creating a vacuum, and then stopping heating and vacuumizing, lowering the specimen temperature to a room temperature, unloading the specimen, weighing the specimen and the specimen tube, and then loading the specimen into an analysis station for analysis, and performing data processing and calculation.

In some embodiments, the electrochemical device satisfies at least one of the following conditions:
(a) Dᵥ₅₀ of particles of the hard carbon is 2 μm to 15 μm, where Dᵥ₅₀ is a particle diameter corresponding to a cumulative volume percent 50% in a volume-based particle size distribution curve.

As an example, the particle diameter Dᵥ₅₀ of particles of the hard carbon corresponding to a cumulative volume percent 50% in a volume-based particle size distribution curve is 2 μm, 4 μm, 6 μm, 8 μm, 10 μm, 12 μm, 15 μm, or a value falling within a range formed by any two thereof.
(b) Dᵥ₉₉ of particles of the hard carbon is 8 μm to 45 μm, where Dᵥ₉₉ is a particle diameter corresponding to a cumulative volume percent 99% in a volume-based particle size distribution curve.

As an example, the particle diameter Dᵥ₉₉ of particles of the hard carbon corresponding to a cumulative volume percent 99% in a volume-based particle size distribution curve is 8 μm, 10 μm, 20 μm, 30 μm, 40 μm, 45 μm, or a value falling within a range formed by any two thereof.

Preferably, the electrochemical device satisfies at least one of the following conditions:
(a′) Dᵥ₅₀ of particles of the hard carbon is 5 μm to 7 μm, where Dᵥ₅₀ is a particle diameter corresponding to a cumulative volume percent 50% in a volume-based particle size distribution curve.

As an example, the particle diameter Dᵥ₅₀ of particles of the hard carbon corresponding to a cumulative volume percent 50% in a volume-based particle size distribution curve is 5 μm, 5.5 μm, 6 μm, 6.5 μm, 7 μm, or a value falling within a range formed by any two thereof.
(b′) Dᵥ₉₉ of particles of the hard carbon is 25 μm to 40 μm, where Dᵥ₉₉ is a particle diameter corresponding to a cumulative volume percent 99% in a volume-based particle size distribution curve.

As an example, the particle diameter Dᵥ₉₉ of particles of the hard carbon corresponding to a cumulative volume percent 99% in a volume-based particle size distribution curve is 25 μm, 30 μm, 35 μm, 40 μm, or a value falling within a range formed by any two thereof.

This application further discloses a preparation process of hard carbon, including the following steps: treating a carbon source to produce a precursor, modifying the precursor, calcining the modified precursor for a first time, grading a calcination product, and calcining a grading product for a second time.

In the step of precursor modification, when the carbon source is biomass corn starch, the precursor modification is usually to place the carbon source in an air atmosphere, and oxidize the carbon source at 150° C. to 180° C. for 5 h to 10 h. When the carbon source is a biomass coconut shell, the precursor modification is usually to soak the carbon source in a sodium hydroxide solution, and hydrothermally heating the carbon source at 150° C. to 180° C. for 5 h to 10 h. When the carbon source is phenolic resin, the precursor modification is the same as that of the biomass corn starch. When the carbon source is asphalt, the carbon source needs to be soaked in a quinoline solution for 5 h to 8 h, and then oxidized at temperatures of 150° C., 200° C., 250° C., and 300° C. separately for 5 h to 10 h to complete the precursor modification of the carbon source.

In the step of the first-time calcination, a product of the precursor modification is placed in an argon or nitrogen atmosphere and calcined at 500° C. to 550° C. for 2 hours.

In the step of second-time calcination, the product of the grading is kept in an argon atmosphere at a temperature of 700° C. to 1000° C. for 2 hours. The preparation process further includes surface modification coating and third-time calcination after the second-time calcination. The temperature of the third-time calcination is 700° C. to 900° C.

In some embodiments, the pyrolysis temperature of the coating layer formed by the surface modification coating is 700° C. to 1000° C.

As an example, the pyrolysis temperature of the coating layer is 700° C., 800° C., 900° C., 1000° C., or a value falling within a range formed by any two thereof.

As an example, the temperature of the third-time calcination is 850° C., 900° C., 920° C., 950° C., or a value falling within a range formed by any two thereof.

An exemplary method for preparing a negative electrode plate includes the following steps:
(1) Dissolving hard carbon, a binder, and a dispersant in a solvent at a specified mass ratio to form a negative electrode slurry;
(2) Applying the negative electrode slurry onto a negative current collector to form a negative active material layer; and
(3) Drying, cold-pressing, and cutting the negative current collector coated with the negative active material layer in step (2), so as to obtain a negative electrode plate.

### Others

The positive electrode plate includes a positive current collector and a positive active material layer applied onto at least one surface of the positive current collector. The positive active material in the positive active material layer may be one or more compounds selected from lithium cobalt oxide, lithium nickel oxide, lithium manganese oxide, lithium nickel manganese oxide, lithium nickel cobalt manganese oxide, lithium nickel cobalt aluminum oxide, or lithium iron phosphate, or a compound formed by adding another transition metal or non-transition metal into any one of such compounds.

As an example, the positive current collector may be made of a metal foil or a porous metal sheet or another material, for example, a foil or porous plate made of a metal such as aluminum, copper, nickel, titanium, or iron, or an alloy thereof, such as an aluminum foil.

The positive electrode plate may be prepared by a conventional method in this field.

The type of the separator is not limited, and may be selected according to actual needs. For example, the separator may be made of, but not limited to, polyethylene, polypropylene, polyvinylidene difluoride, or a multilayer composite thereof.

The electrolyte solution includes an organic solvent, an electrolyte lithium salt, and an additive. The type of the organic solvent is not particularly limited herein, and may be selected according to actual needs.

As an example, the organic solvent may include one or more of, and preferably two or more of: ethylene carbonate (EC), propylene carbonate (PC), ethyl methyl carbonate (EMC), diethyl carbonate (DEC), dimethyl carbonate (DMC), dipropyl carbonate (DPC), methyl propyl carbonate (MPC), ethylene propyl carbonate (EPC), butylene carbonate (BC), fluoroethylene carbonate (FEC), methyl formate (MF), methyl acetate (MA), ethyl acetate (EA), propyl acetate (PA), methyl propionate (MP), ethyl propionate (EP), propyl propionate (PP), methyl butyrate (MB), ethyl butyrate (EB), 1,4-butyrolactone (GBL), sulfolane (SF), methyl sulfonyl methane (MSM), ethyl methyl sulfone (EMS), or (ethylsulfonyl) ethane (ESE).

As an example, the electrolyte lithium salt includes one or more of LiPF₆ (lithium hexafluorophosphate), LiBF₄ (lithium tetrafluoroborate), LiClO₄ (lithium perchlorate), LiAsF₆ (lithium hexafluoroarsenate), LiFSI (lithium bisfluorosulfonimide), LiTFSI (lithium bistrifluoromethanesulfonimide), LiTFS (lithium trifluoromethanesulfonate), LiDFOB (lithium difluoro (oxalato) borate), LiBOB (lithium bis(oxalato)borate), LiPO₂F₂ (lithium difluorophosphate), LiDFOP (lithium difluoro(bisoxalato)phosphate), or LiTFOP (lithium tetrafluoro(oxalato)phosphate).

Optionally, the electrolyte solution further includes an additive. The type of the additive is not particularly limited herein, and may be any additive suitable for use in a lithium-ion battery and may be selected according to actual needs. As an example, the additive may be one or more of vinylene carbonate (VC), vinyl ethylene carbonate (VEC), succinonitrile (SN), adiponitrile (AND), 1,3-propene sultone (PST), sulfonate cyclic quaternary ammonium salt, tris(trimethylsilane)phosphate (TMSP), or tris(trimethylsilane)borate (TMSB).

The electrolyte solution may be prepared by a conventional method in this field.

The electrochemical device may be prepared by a conventional method in this field. An exemplary method is: Stacking the positive electrode plate, the separator, and the negative electrode plate in sequence in such a way that the separator is located between the positive electrode plate and the negative electrode plate to serve a function of separation, so as to obtain an electrode assembly, or, winding the above components to obtain an electrode assembly; and putting the electrode assembly into a packaging shell, injecting an electrolyte solution, and sealing the shell to obtain an electrochemical device.

The electrochemical device of this application may include any device in which an electrochemical reaction occurs. Specific examples of the electrochemical device include all types of primary batteries or secondary batteries. In particular, the electrochemical device is a lithium secondary battery, including a lithium metal secondary battery, a lithium-ion secondary battery, a lithium polymer secondary battery, or a lithium-ion polymer secondary battery.

### Electronic Device

The electronic device of this application contains any one of the electrochemical devices disclosed herein above. The electronic device according to this application is applicable to, but not limited to use in, a notebook computer, pen-inputting computer, mobile computer, e-book player, portable phone, portable fax machine, portable photocopier, portable printer, stereo headset, video recorder, liquid crystal display television set, handheld cleaner, portable CD player, mini CD-ROM, transceiver, electronic notepad, calculator, memory card, portable voice recorder, radio, backup power supply, motor, automobile, motorcycle, power-assisted bicycle, bicycle, lighting appliance, toy, game console, watch, electric tool, flashlight, camera, large household battery, lithium-ion capacitor, and the like.

### Embodiments

### 1. Synthesizing a Hard Carbon Material

Hard carbon (with an H/C value ranging from 0.05 to 0.18) powder is made from resin, biomass materials such as coconut shell or asphalt through steps such as precursor modification, first-time calcination, grading, and second-time calcination.

Synthesis of hard carbon 1: Oxidizing biomass corn starch as a feedstock at 180° C. for 5 hours in an air atmosphere (precursor modification), and then calcining the resultant product at 500° C. for 2 hours in an argon atmosphere in a tube furnace (first-time calcination). Cooling down the calcination product, crushing and grading the calcination product (removing large particles below 400 mesh), and then calcining the grading product for a second time. Increasing the temperature to 1000° C. in the argon atmosphere, keeping the temperature for 2 hours, and then cooling down to obtain a final product, denoted as hard carbon 1.

In the following embodiments, the same steps produces the same effect, the details of which are omitted herein.

Synthesis of hard carbon 2: Crushing a biomass coconut shell into particles of 1 mm or less in diameter, washing the particles with clean water, loading the particles into a reactor, soaking the particles in a 1 mol/L sodium hydroxide solution, and hydrothermally heating the specimens at 180° C. for 5 hours (precursor modification); taking out the particles, oven-drying the particles, and calcining the particles at 500° C. in an argon atmosphere in a tube furnace for 2 hours; cooling down, crushing and grading the particles (removing large particles below 400 mesh), and washing the particles with deionized water until the water reaches a neutral pH level; oven-drying the washed particles, calcining the particles for a second time, putting the calcined particles in an argon atmosphere, increasing the temperature to 1100° C. and keeping the temperature for 2 hours, and then cooling down; subsequently, performing CVD coating at 900° C. in a 10% CH₄—Ar mixed gas (that is, the coating atmosphere is a mixed gas in which CH4 accounts for 10 wt %) for 1 hour (surface modification coating and third-time calcination), so as to obtain a product denoted as hard carbon 2, in which the pyrolysis temperature of the formed coating layer is 750° C.

The synthesis of hard carbon 3 is similar to that of hard carbon 2 except that the second-time calcination temperature is changed to 850° C., no CVD coating or third-time calcination is performed, and the resultant product is denoted as hard carbon 3.

The synthesis of hard carbon 4 is similar to that of hard carbon 2 except that the second-time calcination temperature is changed to 700° C., no CVD coating or third-time calcination is performed, and the resultant product is denoted as hard carbon 4.

Synthesis of hard carbon 5: Using phenolic resin as a feedstock, oxidizing the feedstock at 180° C. in an air atmosphere for 5 hours, and then calcining the feedstock at 500° C. in an argon atmosphere in a tube furnace for 2 hours; cooling down, crushing and grading the feedstock (removing large particles below 400 mesh), and then performing a second-time calcination, putting the feedstock in an argon atmosphere, increasing the temperature to 1200° C. and keeping the temperature for 2 hours, and then cooling down; subsequently, performing CVD coating at 900° C. in a 10% CH₄—Ar mixed gas (that is, the coating atmosphere is a mixed gas in which CH₄ accounts for 10 wt %) for 1 hour, so as to obtain a product denoted as hard carbon 5, in which the pyrolysis temperature of the formed coating layer is 750° C.

The synthesis of hard carbon 6 is similar to that of hard carbon 5 except that the second-time calcination temperature is changed to 900° C., no CVD coating or third-time calcination is performed, and the resultant product is denoted as hard carbon 6.

The synthesis of hard carbon 7 is similar to that of hard carbon 5 except that the second-time calcination temperature is changed to 700° C., no CVD coating or third-time calcination is performed, and the resultant product is denoted as hard carbon 7.

Synthesis of hard carbon 8: Using petroleum asphalt as a feedstock, soaking asphalt particles of 15 μm in a particle diameter of Dᵥ₅₀ in quinoline for 5 hours; suction-filtering and oven-drying the asphalt particles, and then oxidizing the particles in a flowing air atmosphere for 5 hours at each of the following temperatures separately: 150° C., 200° C., 250° C., and 300° C. (precursor modification); and then calcining the particles at 500° C. in an argon atmosphere in a tube furnace for 2 hours; cooling down, crushing and grading the particles (removing large particles below 400 mesh), and then performing a second-time calcination, putting the particles in an argon atmosphere, increasing the temperature to 1100° C. and keeping the temperature for 2 hours, and then cooling down; subsequently, performing CVD coating at 900° C. in a 10% CH₄—Ar mixed gas (that is, the coating atmosphere is a mixed gas in which CH4 accounts for 10 wt %) for 1 hour, so as to obtain a product denoted as hard carbon 8.

The synthesis of hard carbon 9 is similar to that of hard carbon 8 except that the second-time calcination temperature is changed to 900° C., no CVD coating or third-time calcination is performed, and the resultant product is denoted as hard carbon 9.

The synthesis of hard carbon 10 is similar to that of hard carbon 8 except that the second-time calcination temperature is changed to 700° C., no CVD coating or third-time calcination is performed, and the resultant product is denoted as hard carbon 10.

Synthesis of hard carbon 11: Crushing a biomass coconut shell into particles of 1 mm or less in diameter, washing the particles with clean water, loading the particles into a reactor, soaking the particles in a 1 mol/L sodium hydroxide solution, and hydrothermally heating the specimens at 180° C. for 5 hours (precursor modification); taking out the particles, oven-drying the particles, and calcining the particles at 500° C. in an argon atmosphere in a tube furnace for 2 hours; cooling down, crushing and grading the particles (removing large particles below 400 mesh), and washing the particles with deionized water until the water reaches a neutral pH level; oven-drying the washed particles, calcining the particles for a second time, putting the calcined particles in an argon atmosphere, increasing the temperature to 1200° C. and keeping the temperature for 2 hours, and then cooling down.

Synthesis of hard carbon 12: The synthesis of hard carbon 12 is similar to that of hard carbon 2 except that the second-time calcination temperature is changed to 600° C., no CVD coating or third-time calcination is performed, and the resultant product is denoted as hard carbon 12.

Synthesis of hard carbon 13: Crushing a biomass coconut shell into particles of 1 mm or less in diameter, washing the particles with clean water, loading the particles into a reactor, soaking the particles in a 1 mol/L sodium hydroxide solution, and hydrothermally heating the specimens at 180° C. for 5 hours (precursor modification); taking out the particles, oven-drying the particles, and calcining the particles at 500° C. in an argon atmosphere in a tube furnace for 2 hours; cooling down, crushing and grading the particles (removing large particles below 400 mesh), and washing the particles with deionized water until the water reaches a neutral pH level; oven-drying the washed particles, calcining the particles for a second time, putting the calcined particles in an argon atmosphere, increasing the temperature to 1000° C. and keeping the temperature for 2 hours, and then cooling down.

Synthesis of hard carbon 14: identical to that of hard carbon 13.

The graphite is commercially available artificial graphite.

Biomass corn starch, biomass coconut shell, phenolic resin, and petroleum asphalt are all commercially acquired. For example, the manufacturer of biomass corn starch is Aladdin Reagent, and the manufacturer of petroleum asphalt is Liaoning Hongyu Carbon & Graphite Materials Co., Ltd.

### 2. Preparing a Negative Electrode

Mixing above-prepared the hard carbon material as a negative active material, mixing well the negative active material with styrene-butadiene rubber (SBR) and sodium carboxymethyl cellulose (CMC) at a mass ratio of 97:2:1 in an appropriate amount of deionized water to form a homogeneous negative electrode slurry, in which the solid content is 40 wt %. Coating a negative current collector (copper foil) with the slurry, drying the slurry at 85° C., performing cold pressing, cutting, and slitting, and then drying the foil under a 120° C. vacuum condition for 12 hours to obtain a negative electrode.

### 3. Preparing a Positive Electrode

Mixing well the lithium cobalt oxide (LiCoO₂) as a positive active material, Super P as a conductive agent, and polyvinylidene difluoride (PVDF) as a binder at a mass ratio of 97:1.4:1.6 in an appropriate amount of N-methylpyrrolidone (NMP) solvent to form a homogeneous positive electrode slurry, in which the solid content is 72 wt %. Coating a positive current collector aluminum foil with the slurry, drying the slurry at 85° C., performing cold pressing, cutting, and slitting, and then drying the foil under an 85° C. vacuum condition for 4 hours to obtain a positive electrode.

### 4. Preparing an Electrolyte Solution

Mixing well ethylene carbonate (EC), ethyl methyl carbonate (EMC), and diethyl carbonate (DEC) in a dry argon atmosphere glovebox at a mass ratio of EC:EMC:DEC=30:50:20, adding a lithium salt LiPF₆. Stirring well to obtain an electrolyte solution. Based on the mass of the electrolyte solution, the mass percent of LiPF₆ is 12.5%.

### 5. Preparing a Separator

Using a 7-μm-thick polyethylene (PE) porous polymer film as a separator.

### 6. Preparing a Lithium-Ion Battery

Stacking the positive electrode, the separator, and the negative electrode, placing the separator between positive electrode and the negative electrode to serve a separation function, winding the stacked structure to obtain electrode assembly, welding tabs to the electrode assembly, putting the electrode assembly into an outer package aluminum-plastic film, and injecting the electrolyte solution into the package. Performing steps such as vacuum packaging, standing, chemical formation, shaping, and capacity grading to obtain a pouch-type lithium-ion battery.

### 7. Method for Testing the First-Cycle Coulombic Efficiency of the Lithium-Ion Battery

The first-cycle reversible gravimetric capacity of the negative active material at 0 V to 2.0 V can be determined by the following test method: taking a negative electrode plate coated a negative active material on a single side, cutting the electrode plate into pieces of a specified area, and using the cut-out electrode plate as a working electrode; subsequently, using a lithium sheet (or sodium sheet, or the like) as a counter electrode, using a porous polyethylene film as a separator, injecting an electrolyte solution, and fitting the components together to obtain a button battery. Discharging the button battery at three low currents in three different stages until the voltage reaches 0 V, where the three low currents are 0.05 C, 50 μA, and 20 μA respectively, and recording a first-cycle discharge capacity of the button battery; and then charging the battery at a constant current of 0.1 C until a voltage of 2.0 V, and recording the first-cycle charge capacity of the button battery. Calculating the first-cycle Coulombic efficiency as: first-cycle Coulombic efficiency=(first-cycle charge capacity/first-cycle discharge capacity)×100%. Calculating the first-cycle reversible gravimetric capacity of the negative active material cycled at 0 V to 2.0 V as: first-cycle reversible gravimetric capacity=first-cycle charge capacity of the button battery/mass of the negative active material. The specific constituents of the electrolyte solution are not particularly limited. For example, the electrolyte solution may be a LiPF₆ solution with a concentration of 1 mol/L, and the solvent may be made of ethylene carbonate (EC) and diethyl carbonate (DEC) mixed at a mass ratio of 1:1.

### 8. Method for Testing the Severity of Lithium Precipitation of the Negative Electrode

Leaving a to-be-tested lithium-ion battery to stand for 5 minutes under a temperature of 0° C., charging the battery at a constant current of 0.8 C until the voltage reaches 4.45 V, charging the battery at a constant voltage of 4.45 V until the current reaches 0.05 C, leaving the battery to stand for 5 minutes, then discharging the battery at a constant current of 0.5 C until a voltage of 2 V, and leaving the battery to stand for 5 minutes. Repeating the foregoing charging and discharging process for 10 cycles, and then fully charging the battery, disassembling the battery in a dry room, and taking photos to record the status of the negative electrode.

Determining the severity of lithium precipitation: The degree of lithium precipitation is determined based on the status of the negative electrode taken out of a disassembled fully charged battery. When the negative electrode plate is black on the whole and the gray area of the negative electrode is less than 2%, it is determined that no lithium precipitation occurs. When a majority of the negative electrode is black, but some positions of the negative electrode plate are gray, and the gray area accounts for 2% to 20%, it is determined that slight lithium precipitation occurs. When a part of the negative electrode is gray, but a black part of the negative electrode is still seen, and the gray area accounts for 20% to 60%, it is determined that lithium precipitation occurs. When a majority of the negative electrode is gray, and the gray area is greater than 60% of the negative electrode, it is determined that severe lithium precipitation occurs.

### 9. Definition of the H/C Ratio of Negative Electrode Material

Definition of the H/C value: The H/C value is a molar ratio of H element to C element in the hard carbon. The H element and C element are determined by an elemental analyzer. The test instrument is a UNICUBE elemental analyzer. The molar percent of H₂O and CO₂ is measured after the hard carbon is fully burned in a highly pure oxygen environment, so as to obtain the molar ratio, that is, H/C value.

### 10. Differential Scanning Calorimetry (DSC) Test

Disassembling a fully charged lithium-ion battery, and taking out a negative electrode plate. Acquiring the thermal weight loss peak of the negative electrode plate in a range of 0 to 500° C. by differential scanning calorimetry.

TABLE 1

| | | | | | | Energy |
|---|---|---|---|---|---|---|
| | | H/C | Raman | CB | Lithium precipitation | density |
| Type of hard carbon | Battery | value | (I_{d}/I_{g}) | value | degree | (Wh/kg) |
| Biomass-hard carbon 1 | Embodiment 1 | 0.09 | 0.95 | 0.98 | No | 588 |
| Biomass-hard carbon 2 | Embodiment 2 | 0.07 | 0.88 | 0.98 | No | 578 |
| Biomass-hard carbon 3 | Embodiment 3 | 0.12 | 0.99 | 1.00 | No | 595 |
| Biomass-hard carbon 4 | Embodiment 4 | 0.15 | 1.15 | 1.00 | No | 580 |
| Resin-hard carbon 5 | Embodiment 5 | 0.05 | 0.77 | 0.96 | No | 583 |
| Resin-hard carbon 6 | Embodiment 6 | 0.08 | 1.02 | 0.98 | No | 589 |
| Resin-hard carbon 7 | Embodiment 7 | 0.14 | 1.12 | 1.00 | No | 579 |
| Asphalt-hard carbon 8 | Embodiment 8 | 0.06 | 0.84 | 0.97 | No | 596 |
| Asphalt-hard carbon 9 | Embodiment 9 | 0.12 | 1.01 | 1.00 | No | 609 |
| Asphalt-hard carbon 10 | Embodiment 10 | 0.15 | 1.2 | 1.00 | No | 621 |
| Artificial graphite | Comparative Embodiment 1 | 0 | 0.1 | 1.00 | Moderate lithium | 674 |
| | | | | | precipitation | |
| Biomass-hard carbon 11 | Comparative Embodiment 2 | 0.04 | 0.6 | 1.00 | Slight lithium | 428 |
| | | | | | precipitation | |
| Biomass-hard carbon 12 | Comparative Embodiment 3 | 0.20 | 1.25 | 0.99 | Slight lithium precipitation | 513 |
| Biomass-hard carbon 13 | Comparative Embodiment 4 | 0.09 | 0.95 | 0.94 | Moderate lithium | 489 |
| | | | | | precipitation | |
| Biomass-hard carbon 14 | Comparative Embodiment 5 | 0.09 | 0.95 | 1.06 | No lithium precipitation | 439 |

As can be seen from Table 1, in order to avoid lithium precipitation, a conventional CB value of graphite is generally set to 1.05 to 1.08. The graphite in Comparative Embodiment 1 is prone to lithium precipitation when the CB value is overly small. When hard carbon is used as a negative electrode material, the CB value is significantly reduced without lithium precipitation. When the H content is low, for example, when the H/C value is equal to 0.05, the CB value can be as low as 0.96 without causing lithium precipitation at the negative electrode, and the lithium-ion battery possesses a relatively high energy density.

In addition, as can be seen from Comparative Embodiments 2 and 3 versus Embodiments 1 to 10, an appropriate H/C value (0.05 to 0.18) can avoid lithium precipitation at the negative electrode, and the lithium-ion battery possesses a relatively high energy density.

As can be seen from Comparative Embodiments 4 and 5 versus Embodiments 1 to 10, an appropriate CB value (0.95 to 1.05) can avoid lithium precipitation at the negative electrode, and the lithium-ion battery possesses a relatively high energy density.

As can be seen from the experimental data, the H/C value and the CB value coordinate with each other. When the H/C value and the CB value both meet the specified value ranges, the lithium-ion battery achieves a relatively high energy density, without lithium precipitation at the negative electrode.

Hard carbon possesses potential advantages in gravimetric energy density and fast charge-discharge performance, and can be used in power batteries, electric tools, unmanned aerial vehicles, and other fields.

The preparation method of the hard carbon in Embodiments 12 to 13 is similar to that of hard carbon 2. However, the particles are specially graded. In the grading in Embodiment 12, a small-particle part is taken. In the grading in Embodiment 13, a large-particle part is taken. The particle size distribution in Embodiment 2 is identical to that in Embodiment 12 and Embodiment 13, in which the constituents are mixed at a mass ratio of 1:1. The specific particle size distribution is shown in Table 2. In Embodiments 14 to 16, hard carbon 5 is prepared. The particle size distribution in Embodiment 16 is identical to that in Embodiments 14 and 15, in which the constituents are mixed at a mass ratio of 1:1. The relevant parameters are shown in the following table.

TABLE 2

| | | | | Compacted | | | | First-cycle | Occurrence | Energy |
|---|---|---|---|---|---|---|---|---|---|---|
| | Dᵥ₅₀ | Dᵥ₉₉ | BET | density P | | DSC | CB | Coulombic | of lithium | density |
| | (μm) | (μm) | (m^{2/}g) | (g/cm³) | BET/P | (J/g) | value | efficiency | precipitation | (Wh/kg) |
| Embodiment 2 | 5.1 | 27.5 | 5.16 | 1.02 | 5.06 | 124.6 | 0.98 | 79% | No | 578 |
| Embodiment 12 | 3 | 8.2 | 8.71 | 1 | 8.71 | 115.7 | 0.98 | 78.5% | No | 570 |
| Embodiment 13 | 10.5 | 31.4 | 1.64 | 0.96 | 1.70 | 102.6 | 1.00 | 79% | No | 563 |
| Embodiment 14 | 2.9 | 7.8 | 8.5 | 1 | 8.5 | 120.9 | 0.96 | 83.7% | No | 572 |
| Embodiment 15 | 12.3 | 35.4 | 1.59 | 0.95 | 1.67 | 111.1 | 0.98 | 84% | No | 566 |
| Embodiment 16 | 5.3 | 30.6 | 5.07 | 1.02 | 4.97 | 138.9 | 0.96 | 84% | No | 586 |
| Embodiment 5 | 7 | 38 | 4.2 | 1 | 4.2 | 121.3 | 0.96 | 84% | No | 583 |

The values in the DSC column represent the thermal weight loss peak area of the negative electrode plate in a temperature range of 150° C. to 220° C.

As can be seen from Table 2, the particle size distribution of the specimens affects the specific surface area of the hard carbon and the compacted density of the negative electrode plate, and therefore, affects the energy density. When the hard carbon material contains large and small particles combined together, the hard carbon material is most conducive to increasing the compacted density of the electrode plate and the energy density, and the lithium ions are intercalated and migrated for an appropriate distance, so that the lithium-ion battery achieves good kinetic performance and the lithium precipitation of the electrode plate is alleviated. In the DSC column in the table, the thermal weight loss peak area in the temperature range of 150° C. to 220° C. represents the thermal weight loss peak of metallic lithium or the like in the micropores of hard carbon in the negative electrode plate, and indicates that a reasonable combination of hard carbon particles allows the negative electrode to store more metallic lithium or the like in the same area, thereby also reflecting an increase in the energy density of the lithium-ion battery. As can be seen, selecting a hard carbon material containing large and small particles combined together can alleviate the lithium precipitation of the negative electrode of the lithium-ion battery and increase the energy density of the lithium-ion battery. When the BET/P ratio is not less than 1.7, the exertion of the energy density and kinetics of the lithium-ion battery can be prevented from being hindered by a low compacted density and a low BET specific surface area of the electrode plate caused by an excessive number of large particles stacked together.

The foregoing descriptions are merely exemplary embodiments of this application, but are not intended to limit this application. Any modifications, equivalent substitutions, and improvements made without departing from the spirit and principles of this application still fall within the protection scope of this application.

What is claimed is:

1. An electrochemical device, comprising a negative electrode plate and a positive electrode plate; wherein the negative electrode plate comprises a negative active material layer, a negative active material in the negative active material layer comprises hard carbon, wherein an H/C value of the hard carbon is 0.05 to 0.18, and a CB value of the electrochemical device is 0.95 to 1.05, wherein
the H/C value is a molar ratio of H element to C element in the hard carbon, and the CB value is a ratio of a capacity per unit area of the negative electrode plate to a capacity per unit area of the positive electrode plate.

2. The electrochemical device according to claim 1, wherein the H/C value is 0.05 to 0.15.

3. The electrochemical device according to claim 2, wherein the H/C value is 0.08 to 0.15.

4. The electrochemical device according to claim 1, wherein the CB value is 0.96 to 1.00.

5. The electrochemical device according to claim 4, wherein the CB value is 0.98 to 1.00.

6. The electrochemical device according to claim 1, wherein, in a thermal analysis test, the negative electrode plate in a fully charged state exhibits a thermal weight loss peak in a range of 150° C. to 220° C., with a peak area being greater than 100 J/g.

7. The electrochemical device according to claim 1, wherein, in an X-ray diffraction pattern of the negative electrode plate, a diffraction peak A1 is exhibited in a range of 20° to 30° and has a full-width-at-half-maximum of 3° to 10°.

8. The electrochemical device according to claim 1, wherein, in a Raman spectrum of the negative electrode plate, a characteristic peak D1 is exhibited in a range of 1320 cm⁻¹ to 1370 cm⁻¹, a characteristic peak G1 is exhibited in a range of 1570 cm⁻¹ to 1620 cm⁻¹, a peak intensity of the characteristic peak D1 is I_{D1}, and a peak intensity of the characteristic peak G1 is I_{G1}, and 0.5≤I_{D1}/I_{G1}≤1.5.

9. The electrochemical device according to claim 1, wherein a BET specific surface area of the hard carbon is 1.5 m²/g to 10 m²/g.

10. The electrochemical device according to claim 1, wherein a compacted density of the negative electrode plate is P, and 0.85 g/cm³≤P≤1.1 g/cm³.

11. The electrochemical device according to claim 1, wherein a ratio of a value of the BET specific surface area expressed in m²/g of the hard carbon to a value of the compacted density expressed in g/cm³ is M, and M>1.7.

12. The electrochemical device according to claim 1, wherein the electrochemical device satisfies at least one of the following conditions:
(a) Dᵥ₅₀ of particles of the hard carbon is 2 μm to 15 μm, wherein Dᵥ₅₀ is a particle diameter corresponding to a cumulative volume percent 50% in a volume-based particle size distribution curve; or
(b) Dᵥ₉₉ of particles of the hard carbon is 8 μm to 45 μm, wherein Dᵥ₉₉ is a particle diameter corresponding to a cumulative volume percent 99% in a volume-based particle size distribution curve.

13. The electrochemical device according to claim 9, wherein the BET specific surface area of the hard carbon is 2 m²/g to 8 m²/g.

14. The electrochemical device according to claim 10, wherein 0.98 g/cm³≤P≤1.05 g/cm³.

15. The electrochemical device according to claim 11, wherein 2≤M≤9.

16. The electrochemical device according to claim 12, wherein Dᵥ₅₀ of particles of the hard carbon is 5 μm to 7 μm.

17. The electrochemical device according to claim 12, wherein Dᵥ₉₉ of particles of the hard carbon is 25 μm to 40 μm.

18. A method for preparing the hard carbon as claimed in claim 1, the method comprising the following steps:
treating a carbon source to produce a precursor, modifying the precursor, calcining the modified precursor for a first time, grading a calcination product, and calcining a grading product for a second time, wherein
the carbon source comprises any one of resin, a biomass carbon material, or asphalt; and
when a temperature of the second-time calcination is higher than 1000° C., the preparation process further comprises surface modification coating and third-time calcination after the second-time calcination.

19. The method according to claim 18, wherein a coating layer is formed from the surface modification coating; and
a pyrolysis temperature of the coating layer is 700° C. to 1000° C., and a temperature of the third-time calcination is 700° C. to 900° C.

20. An electronic device, comprising an electrochemical device; the electrochemical device comprising a negative electrode plate and a positive electrode plate; wherein the negative electrode plate comprises a negative active material layer, a negative active material in the negative active material layer comprises hard carbon, wherein an H/C value of the hard carbon is 0.05 to 0.18, and a CB value of the electrochemical device is 0.95 to 1.05, wherein
the H/C value is a molar ratio of H element to C element in the hard carbon, and the CB value is a ratio of a capacity per unit area of the negative electrode plate to a capacity per unit area of the positive electrode plate.
